(19) United States
(12) Patent Application Publication
(10) Pub. No.: US 2002/0163893 A1
(43) Pub. Date: Nov. 7, 2002

(54) Method for operating a radio-based communication system

(75) Inventor: Michael Jeschke, Stuttgart (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/135,407

(22) Filed: May 1, 2002

(30) Foreign Application Priority Data
May 7, 2001 (DE) 101 22 099.5

(51) Int. Cl. H04Q 7/00

(52) U.S. Cl. 370/330; 370/345; 370/336

(57) ABSTRACT

A method for operating a radio-based communication system is described. During a first time slot (UL) the sending of data from a first mobile station (UE2) to a base station (node B) is provided. During a second time slot (DL) the receiving of data from the base station (node B) in the first mobile station (UE2) is provided. The first and second time slots (DL, UL) are provided in succession for an exchange of data. Normal codes (C2U, C2D) are allocated to the data exchanged in this way between the first mobile station (UE2) and the base station (node B). A second mobile station (UE2) sends data with a special code (C2*) in the first time slot (UL) and the first mobile station (UE1) receives the data with the special code (C2*) in the first time slot (UL).

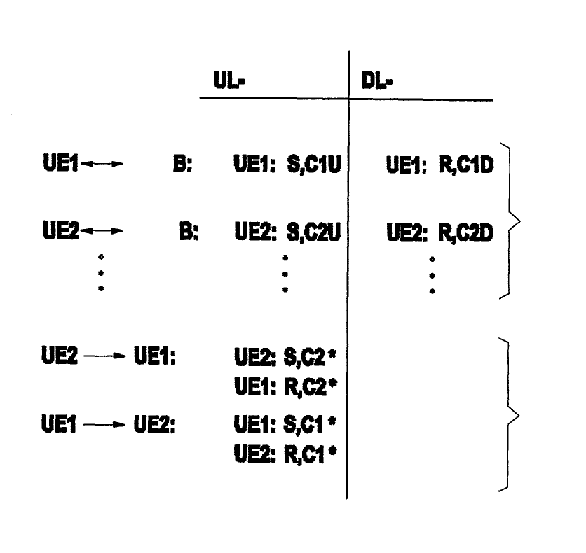

### BACKGROUND OF THE INVENTION

The invention is related to a method for operating a radio-based communication system, in which during a first time slot the sending of data by a first mobile station to a base station is provided, in which during a second time slot the receiving of data from the base station in the first mobile station is provided, in which the first and second time slots are provided in succession for the exchange of data, and in which normal codes are allocated to the data exchanged in this way between the first mobile station and the base station, the method comprising a step wherein a second mobile station sends data with a special code in the first time slot and the first mobile station receives the data with the special code in the first time slot. The invention further relates to a corresponding radio-based communication system and a corresponding mobile station for this.

The invention is based on a priority application DE 101 22 099.5 which is hereby incorporated by reference.

### SUMMARY OF THE INVENTION

A method of this kind is known from the CDMA communication system (CDMA=code division multiple access). There, using the TDD method (TDD=time division duplex), it is provided that a mobile station may send data to a base station during a so-called uplink time slot, but may not send data during a so-called downlink time slot, but can only receive data from the base station. The data associated with different mobile stations are therein distinguished from one another with the aid of a code.

In a communication system of this kind, communication between two mobile stations is possible only via the base station. Direct communication is not possible.

It is the object of the invention to create a method of the initially mentioned kind, with which direct communication between two mobile stations is possible without intermediate switching of the associated base station.

This object is achieved by the method for operating a radio-based communication system, in which during a first time slot the sending of data by a first mobile station to a base station is provided, in which during a second time slot the receiving of data from the base station in the first mobile station is provided, in which the first and second time slots are provided in succession for the exchange of data, and in which normal codes are allocated to the data exchanged in this way between the first mobile station and the base station, the method comprising a step wherein a second mobile station sends data with a special code in the first time slot and the first mobile station receives the data with the special code in the first time slot. The object is also achieved by the mobile station for a radio-based communication system, in which during a first time slot the sending of data to a base station is provided, in which during a second time slot the receiving of data from the base station is provided, in which the first and second time slots are provided in succession for an exchange of data and in which normal codes are allocated to the data exchanged in this way between the mobile station and the base station, said mobile station sending data with a special code is provided in the first time slot, so that the data with the special code can be received by another mobile station in the first time slot and also by the communication system, in which during a first time slot the sending of data from a first mobile station to a base station is provided, in which during a second time slot the receiving of data from the base station in the first mobile station is provided, in which the first and second time slots are present in succession for an exchange of data and in which normal codes are allocated to the data exchanged in this way between the first mobile station and the base station, wherein a second mobile station is provided for sending data with a special code in the first time slot and the first mobile station is provided for receiving the data with the special code in the first time slot.

According to the invention the first mobile station sends data during the uplink time slot, not in fact with the normal code, but with the special code. These data with the special code are received by the second mobile station in the uplink time slot. Using the special code the second mobile station can distinguish data intended for it from data intended for the base station. In this way direct communication arises between the two mobile stations, this being with the special code.

As the special code is not used for data intended for the base station, the base station ignores these data.

In an advantageous further development of the invention the second mobile station responds in a subsequent uplink time slot of the first mobile station. For this purpose the second mobile station again sends data with the special code. From this the first mobile station can recognise that these data come from the second mobile station. Altogether direct communication thus arises between the two mobile stations without intermediate switching of the base station being required for this.

The described direct communication between two mobile stations is therein possible without any additional hardware. Simultaneously the direct communication mentioned represents a function desired by many users of communication systems and which can therefore be effectively installed by the operators of the communication systems.

To distinguish those data exchanged between the base station and the mobile parts and those data exchanged during direct communication between two mobile parts, it is provided according to the invention that in both cases different codes are used respectively for transmitting the data.

It is therein particularly advantageous if the codes for the direct communication between two mobile parts are made available by the base station. In this way it is achieved that the direct communication can lead only to a very slight extent—if at all—to disturbances in the reception of the base station.

In a further advantageous development of the invention transmitting of data with the special code is carried out at a reduced transmitting power. This guarantees on the one hand that the data transmitted with the special code from one of the mobile stations during the uplink time slot do not lead to disturbances of the data transmitted per se to the base station with the normal code from other mobile stations in this uplink time slot. On the other hand, however, with the aid of the reduced transmitting power it is nevertheless achieved that two mobile stations, located in spatial proximity to one another, can communicate with one another.

### BRIEF DESCRIPTION OF THE DRAWINGS

Further features, possibilities for application and advantages of the invention emerge from the following description of embodiment examples of the invention illustrated in the drawing. All described or illustrated features therein form on their own or in any desired combination the subject of the invention, irrespective of their summarization in the patent claims or their relation back, as well as irrespective of their formulation or illustration in the description or in the drawing.

The single FIGURE of the drawing shows a schematic illustration of an embodiment example of a method according to the invention for operating a radio-based communication system.

In a CDMA communication system (CDMA=code division multiple access) a base station is present, also designated as node B. This base station covers a specific local area in which it can communicate with a plurality of mobile stations. The mobile stations are also designated as UEs (UE=user equipment).

Communication between the base station and the mobile stations takes place by the time division duplex method (TDD=time division duplex). This means that the frequency at which information is transmitted from the base station to the mobile stations (so-called downlink=DL) is identical to the frequency at which information is transmitted from the mobile stations to the base station (so-called uplink=UL). The distinction between the two transmitting devices, in other words between the uplink and the downlink, takes place with the aid of various time slots, made available by the time division duplex method. Successive time slots are therein provided for the uplink and the downlink.

The base station may therefore transmit information to the mobile stations only during the time slots for the downlink. During these downlink time slots the mobile stations may not send any information to the base station, but here they may only receive the information transmitted from the base station. The reverse applies correspondingly to the time slots for the uplink. In these time slots only the mobile stations may transmit information, which is then received by the base station. The base station may not, however, send any information in this time slot.

With the described method the information to be transmitted is transmitted with specific codes. These codes therein differ as a function of the respective mobile station and the direction of transmission. For example, in the uplink every mobile station which sends information to the base station uses its own code which has been allocated in advance, e.g. by the base station. The aforementioned codes are subsequently designated as normal codes.

These methods and allocations are schematically illustrated in the figure. In a mode characterised as NORMAL a first mobile station UE1 and a second mobile station UE2 communicate with a common base station node B. During the uplink UL the first mobile station UE1 sends (S=to send) data with a normal code C1U to the base station node B. Simultaneously the second mobile station UE2 sends data with a normal code C2U to the same base station node B. During the downlink DL the first mobile station UE1 receives (R=to receive) data from the base station node B with the normal code C1D and the second mobile station UE2 receives data from the base station with the normal code C2D. In this way, with the aid of the normal codes C1U, C2U, C1D, C2D and with the aid of the distinction between uplink and downlink, mutually independent exchange of data between the first mobile station UE1 and the base station node B and between the second mobile station UE2 and the base station node B takes place. It goes without saying that this communication can also be extended to further mobile stations in a corresponding manner.

In a mode designated as INTERCOM direct communication between the two mobile stations UE1 and UE2 is possible without intermediate switching of the base station node B. It is assumed hereinafter that the second mobile station UE2 wishes to begin direct communication of this kind with the first mobile station UE1. It is furthermore assumed that the first mobile station UE1 is set to a so-called Intercom-Receive-Mode, which will be explained in greater detail later.

To start direct communication between two mobile stations, the second mobile station UE2 transmits data during the uplink (see figure: UE2->UE1: S during UL). To send these data a code C2* is used, which is a special code differing from the already described normal codes C1U, C2U, etc. Moreover, the data with the code C2* are transmitted by the mobile station UE2 at a substantially lower transmitting power than would be the case per se in the mode designated as NORMAL, so the base station is disturbed as little as possible.

As the first mobile station UE1 is set to Intercom-Receive-Mode, it is also able to receive data during the uplink, contrary to the mode designated as NORMAL. The first mobile station UE1 therefore receives—as long as it is located in the spatial vicinity of the second mobile station UE2—the data transmitted by the second mobile station UE2 (see figure: UE2->UE1: R during UL). Owing to the special code C2* the first mobile station UE1 recognises that the data are of a kind allocated to a direct communication between two mobile stations and not of a kind intended only for the base station.

The base station node B on its part has not configured a receiver adapted to the special code C2*. The base station node B therefore ignores the associated data. As these data, in addition, are emitted by the second mobile station UE2 at only a very low transmitting power, they also hardly disturb the remaining receipt of data in the base station node B.

During the next uplink, as response, the mobile station UE1 transmits data with a special code C1* and at a substantially reduced transmitting power (see figure: UE1->UE2: S during UL).

The base station node B is set to receiving data from the mobile stations UE1, UE2 during the uplink and could therefore if necessary receive the data transmitted by the first mobile station UE1 in spite of their low transmitting power. The base station node B, however, has not configured a receiver adapted to the special code C1*, so the data are again ignored by the base station node B.

The second mobile station UE2, which initiated the direct communication as described and which is therefore expecting a response from the first mobile station UE1, now switches —contrary to the mode designated as NORMAL—to receipt of data during the uplink (see figure: UE1->UE2: R during UL). Thus far the second mobile station UE2 also switches to Intercom-Receive-Mode, this taking place automatically owing to the direct communication initiated by it. As long as the second mobile station UE2 is located in spatial proximity to the first mobile station UE1, the second mobile station UE2 receives the data transmitted by the first mobile station UE1 during the uplink in spite of its low transmitting power. Using the special code C1* the second mobile station UE2 recognises that these are data which belong to the direct communication with the first mobile station UE1 it initiated itself.

After this the second mobile station UE2 can send further data together with the special code C2* to the first mobile station UE1, as has already been explained in connection with the starting of direct communication. Direct communication can then in this way be continued as long as wished.

A pre-condition for direct communication between the two mobile stations UE1 and UE2 is that they are located in spatial proximity to one another, so the data transmitted by one of the two mobile stations at the reduced transmitting power can be received by the other mobile station.

Furthermore, for direct communication a special code has to be used, which is different from the otherwise used code. This can be achieved in that a set of special codes is present in the communication system, which is provided only for this direct communication and which is not otherwise used. This can also be achieved in that the base station, for example via a so-called broadcast channel, continually communicates to all mobile stations present those codes which can be used by the mobile stations as special codes for direct communication.

As has been explained, the first mobile station UE1 must already be in an Intercom-Receive-Mode when the second mobile station UE2 starts direct communication between the two mobile stations. This can be done in various ways.

It is possible for the user of the first mobile station UE1 to set the Intercom-Receive-Mode on his mobile station manually, e.g. by appropriate programming or by means of a switch provided for this purpose.

It is also possible for the second mobile station UE2 to transmit a special access code CA* in the preceding downlink time slot DL before starting the actual direct communication. As the first mobile station UE1 in the downlink time slot DL in the mode characterised as NORMAL is set to receiving data, it receives this special access code CA*. Using the special access code CA* the first mobile station UE1 recognises that another mobile station wishes to start direct communication. The first mobile station UE1 thereupon switches automatically into Intercom-Receive-Mode, so then the second mobile station UE2 can start direct communication, as described.

The use of the access code CA* is also possible when this is used in the uplink time slot UL. The first mobile station UE1 then admittedly has to be set manually to Intercom-Receive-Mode, but it does not have to “listen” or correlate to all conceivable codes C2* in order to find out whether the second mobile station UE2 wishes to communicate with it. Instead, the first mobile station UE1 “listens” only on a limited set of access codes CA*1, CA*2, . . . , CA*n and then responds also in an uplink slot UL with a code CR*, which depends on the code CA* received. As a special case it can therein emerge that the codes C1* and C2* are identical.

1. Method for operating a radio-based communication system, in which during a first time slot the sending of data by a first mobile station to a base station is provided, in which during a second time slot the receiving of data from the base station in the first mobile station is provided, in which the first and second time slots are provided in succession for the exchange of data, and in which normal codes are allocated to the data exchanged in this way between the first mobile station and the base station, the method comprising a step wherein a second mobile station sends data with a special code in the first time slot and the first mobile station receives the data with the special code in the first time slot.

2. Method according to claim 1, the method comprising a step wherein the first mobile station sends data with the special code in a subsequent first time slot and the second mobile station receives the data with the special code in the first time slot.

3. Method according to claim 1, the method comprising a step wherein the first and/or the second mobile station is switched into a mode in which it/they can receive data in the first time slot.

4. Method according to claim 1, the method comprising a step wherein the special code is chosen as different from the normal code.

5. Method according to claim 1, the method comprising a step wherein the special code is made available to the mobile stations by the base station.

6. Method according to claim 1, the method comprising a step wherein the transmitting of data with the special code is carried out at a reduced transmitting power.

7. A mobile station for a radio-based communication system, in which during a first time slot the sending of data to a base station is provided, in which during a second time slot the receiving of data from the base station is provided, in which the first and second time slots are provided in succession for an exchange of data and in which normal codes are allocated to the data exchanged in this way between the mobile station and the base station, said mobile station sending data with a special code is provided in the first time slot, so that the data with the special code can be received by another mobile station in the first time slot.

8. A radio-based communication system, in which during a first time slot the sending of data from a first mobile station to a base station is provided, in which during a second time slot the receiving of data from the base station in the first mobile station is provided, in which the first and second time slots are present in succession for an exchange of data and in which normal codes are allocated to the data exchanged in this way between the first mobile station and the base station, wherein a second mobile station is provided for sending data with a special code in the first time slot and the first mobile station is provided for receiving the data with the special code in the first time slot.
